(19) United States
(12) Patent Application Publication
(10) Pub. No.: US 2016/0300635 A1
(43) Pub. Date: Oct. 13, 2016

(54) WIRE POWER AND COMMUNICATION ARRANGEMENT

(71) Applicant: Gregory Lawrence Ozga, Grosse Pointe Park, MI (US)

(72) Inventor: Gregory Lawrence Ozga, Grosse Pointe Park, MI (US)

(21) Appl. No.: 14/680,173

(22) Filed: Apr. 7, 2015

(51) Int. Cl. H01B 1/04; H01B 9/02; H01B 9/00; H01B 3/30; H01B 7/02

(52) U.S. Cl. CPC H01B 1/04; H01B 3/30; H01B 7/0216; H01B 9/003; H01B 9/02

(57) ABSTRACT

A wire design having a carbon fiber core including two or more carbon fibers that are electrically conductive. An inner dielectric insulator surrounds the carbon fiber core. Circumscribing the inner dielectric insulator and the carbon fiber core is an electrically conductive woven material. An outer insulator sheath made of non-electrically conductive material circumscribes the electrically conductive woven material, the inner dielectric insulator and the carbon fiber core. The wire design further includes at least one connector at each end of the wire design configured to be in contact with the carbon fiber core, the inner dielectric insulator and the electrically conductive woven material.

### FIELD OF THE INVENTION

The present invention relates to new power and communication wire arrangements used for power supply and communication systems.

### BACKGROUND OF THE INVENTION

In the fields of electronics, communication and artificial lighting there have been constant improvements relating to energy efficiency, processing speed and amount of signal data transmitted by electronics devices and communications equipment. For example computers and “smart” televisions are designed so that their displays consume less power due to the use of light emitting diodes (LEDs) or Liquid Crystal Displays (LCDs). At the same time such devices have powerful processors capable of sending and receiving large amounts through computer networks connected through high speed internet networking lines, thereby requiring greater data bandwidth. In the area of artificial lighting there have been significant changes in the way artificial light is created. Traditional incandescent light bulbs have been replaced by fluorescent and LED light sources that use a fraction of power that incandescent bulbs required.

With all of the above changes to electronics, communications and artificial lighting, the way power is delivered and inputted to devices has for the most part not changed. With regard to electronics, multiple connections are often required to provide both data signals and electrical power to the device. For example a television will be plugged into a power outlet using a traditional wall plug and a data signal wire, such as a co-axial cable wire is also connected to the television to provide a data signal. Some televisions and computers use a wireless data signal to eliminate the need to have a separate co-axial connection, however, the need for greater data bandwidth, due to advances electronics, often leaves wireless data connections lagging behind a hardwired connection.

In the field of lighting, LEDs and fluorescent bulbs quickly replacing traditional incandescent bulbs as well as other light bulbs including halogen and sodium lights. In particular street lights and other outdoor lights, which are illuminated on nightly basis are quickly being replaced with more energy efficient LEDs or fluorescent lights. However, the way the power is provided to these new bulbs has not changed. Typically the electricity is supplied by copper wires, which is quite expensive and has created problems with metal theft. Aluminum wires can be used in place of copper, as a cheaper alternative, but traditional aluminum wires are heat conductive and are prone to oxidation and wire creep.

There is a need to provide new wiring arrangements and systems that will provide both data and power transmission. There is also a need to provide lower voltage wiring designs that are less expensive and address the issues impracticalities of traditional aluminum wire designs.

### SUMMARY OF THE INVENTION

A first aspect of the invention relates to a wire design having a carbon fiber core including two or more carbon fibers that are electrically conductive. An inner dielectric insulator surrounds the carbon fiber core. Circumscribing the inner dielectric insulator and the carbon fiber core is an electrically conductive woven material. An outer insulator sheath made of non-electrically conductive material circumscribes the electrically conductive woven material, the inner dielectric insulator and the carbon fiber core. The wire design further includes at least one connector at each end of the wire design configured to be in contact with the carbon fiber core, the inner dielectric insulator and the electrically conductive woven material.

A second aspect of the invention relates to a wire design having a carbon fiber core of two or more carbon fibers that are electrically conductive. An electrically conductive woven material circumscribes the carbon fiber core and an outer insulator sheath made of non-electrically conductive material circumscribes the electrically conductive woven material and the carbon fiber core. Each end of the wire design has at least one connector configured to be an electrical contact with the carbon fiber core and the electrically conductive woven material.

A third aspect of the invention relates to a wire design having a carbon fiber core of two or more carbon fibers that are electrically conductive. The two or more elongated fibers are wrapped around a flexible backbone in order to support the carbon fibers. An outer insulator sheath made of non-electrically conductive material circumscribes the carbon fiber core and flexible backbone. Each end of the wire design has at least one connector configured to be in contact with the carbon fiber core and the flexible backbone.

A fourth aspect of the invention pertains to a power and communication system that includes a wire or wire design having a carbon fiber core of two or more carbon fibers that are electrically conductive. And inner dielectric insulator circumscribing the carbon fiber core. An electrically conductive woven material circumscribes the inner dielectric insulator in the carbon fiber core. An outer insulator sheath made of non-electrically conductive material circumscribes the electrically conductive woven material, the inner dielectric insulator and the carbon fiber core.

There is at least one input connector at a first end of the wire configured to be in contact with the carbon fiber core, the inner dielectric insulator and the electrically woven material. The power and communication system further includes at least one output connector at a second end of the wire configured to be in contact with the carbon fiber core, the inner dielectric insulator and the electrically conductive woven material. A power source and a signal source is connected to the at least one input connector for simultaneously transmitting a power voltage and a signal voltage. A device is connected to the at least one output connector and receives the power voltage and the signal voltage from the at least one output connector. The device has a separator circuit for separating and directing the power voltage and the signal voltage.

A further aspect of the invention includes a wire design having a carbon fiber core of two or more carbon fibers that are electrically conductive, an inner dielectric insulator circumscribing the carbon fiber core, an electrically conductive woven material circumscribing the inner dielectric insulator and carbon fiber core and an outer insulator sheath made of non-electrically conductive material circumscribing the electrically conductive woven material, the inner dielectric insulator and the carbon fiber core. The two or more carbon fibers are each carbon nanotube fibers. The woven electrically conductive mesh material is one selected from the group consisting of aluminum, copper and combinations thereof.

At least one connector at each end of the wire design configured to be in contact with the carbon fiber core the inner dielectric insulator and the electrically conductive woven material. The at least one connector allows the carbon fiber to pass through the at least one connector. The at least one connector has one or more teeth that penetrate the outer insulation sheath and the one or more teeth contact the carbon fiber core, the inner dielectric insulator and the electrically conductive woven material.

The wire design in another aspect of the invention also includes a flexible backbone of the carbon fiber core, wherein the two or more carbon fibers are wrapped around the flexible backbone in order to support the two or more carbon fibers. The flexible backbone is a thin gauge electrically conductive metal or alloy wire. The flexible backbone is electrically conductive material, one selected from the group consisting of copper, aluminum, steel and combinations thereof.

Another feature of the present invention relates to a power and communication system having a wire having a carbon fiber core of two or more carbon fibers that are electrically conductive, an inner dielectric insulator circumscribing the carbon fiber core. There is an electrically conductive woven material circumscribing the inner dielectric electric insulator and carbon fiber core, an outer insulator sheath made of non-electrically conductive material circumscribing the electrically conductive woven material, the inner dielectric insulator and the carbon fiber core. At least one input connector at a first end of the wire configured to be in contact with the carbon fiber core, the inner dielectric insulator and the electrically conductive woven material. At least one output connector at a second end of the wire configured to be in contact with the carbon fiber core, the inner dielectric insulator and the electrically conductive woven material. A power and signal source connected to the at least one input connector for simultaneously transmitting a power voltage and a signal voltage.

There is also a device connected to the at least one output connector for receiving the power voltage and the signal voltage from the at least one output connector, said device having a separator circuit for separating and directing the power voltage and the signal voltage. The device is connected to an appliance having a separate power voltage input and a separate voltage signal input. The appliance is one selected from the group consisting of a television, computer, entertainment system, DVD player, thermostat, a vehicle computer, a vehicle charging and infotainment system.

The at least one connector at each end of the wire design configured to be in contact with the carbon fiber core the inner dielectric insulator and the electrically conductive woven material. The at least one connector allows the carbon fiber to pass through the at least one connector. In another aspect of the invention, the at least one connector has one or more teeth that penetrate the outer insulation sheath and the one or more teeth contact the carbon fiber core, the inner dielectric insulator and the electrically conductive woven material.

In a further aspect of the invention there is a flexible backbone of the carbon fiber core, wherein the two or more carbon fibers are wrapped around the flexible backbone in order to support the two or more carbon fibers. The flexible backbone is a thin gauge electrically conductive metal or alloy wire. The flexible backbone is electrically conductive material, one selected from the group consisting of copper, aluminum, steel and combinations thereof.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram of a power and communication system;

FIG. 2 is a partially segmented perspective view of a wire design for use with a power and communication system;

FIG. 3 is a cross sectional plan end view taken along section line 3-3 in FIG. 2 of a wire design for use with a power and communication system;

FIG. 4 is a partially segmented perspective view of a wire design for use with a power and communication system;

FIG. 5 is a cross sectional plan end view taken along section line 5-5 in FIG. 4 of a wire design for use with a power and communication system;

FIG. 6 is a partially segmented perspective view of a wire design for use with a power and communication system;

FIG. 7 is a cross sectional plan end view taken along section line 7-7 in FIG. 6 of a wire design for use with a power and communication system; and

FIG. 8 is a cross-sectional plan view of the end of the wire design where the input connector or output connector are connected.

### DETAILED DESCRIPTION OF THE PREFERRED EMBODIMENTS

The following description of the preferred embodiment(s) is merely exemplary in nature and is in no way intended to limit the invention, its application, or uses.

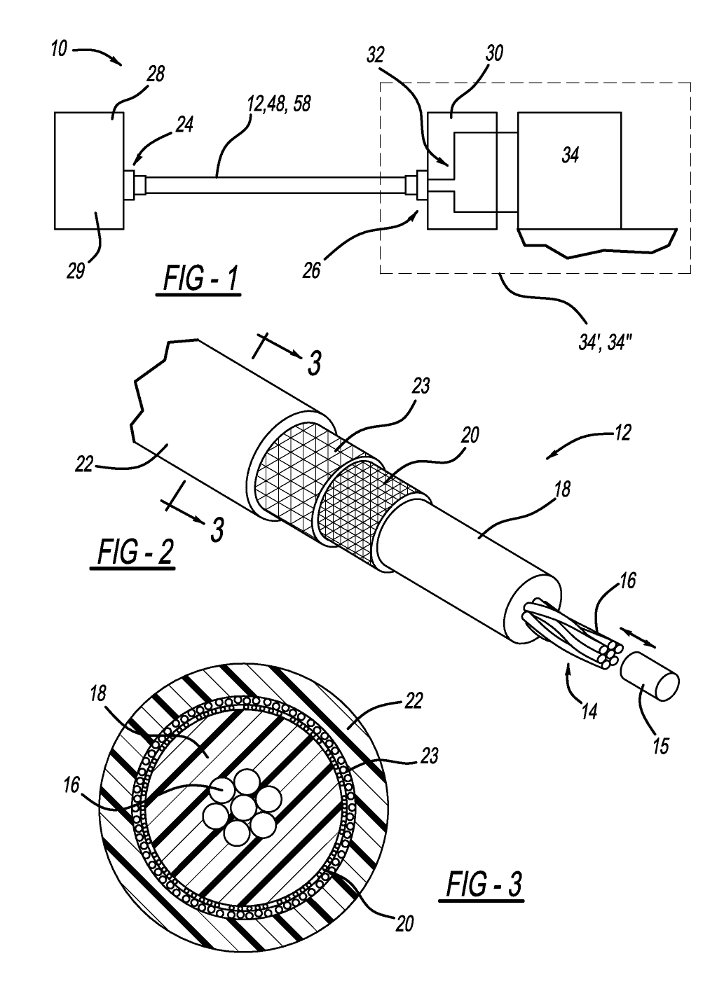

Referring now to FIGS. 1-8 a power and communication system 10 is schematically shown. The power and communication system 10 has a wire design 12, 48, 58, which is also referred to as a wire that can take many different forms depending upon the particular application. Each of the different forms of the wire design 12, 48, 58 are described in the accompanying drawings.

The wire design 12, 48, 58 have a carbon fiber core that includes two or more carbon fibers that are electrically conductive. The carbon fibers of the wire design 12, 40, 58 are carbon fiber reinforced composites such as commercial grade 50K Panex® 35 carbon fibers manufactured by Zoltek Worldwide; St. Louis, Mo. It is also within the scope of this invention for other types of carbon fibers to be utilized, provided that they are electrically conductive and meet the needs of a particular application. In the present invention the carbon fibers are carbon nanotube-based fibers. Such fibers are capable of transmitting nearly about 1000 times more current than copper. An example of suitable carbon nanotube-based fibers include carbon nanotube fibers coextruded with polymerized aramid polymers. The carbon nanotube fibers are intertwined in order to create strands of suitable thickness. The present embodiment of the invention shows multiple strands, however the number of strands needed for a particular application will vary depending on the amount of voltage and current that the wire design 12, 48, 58 is expected to carry.

The wire design 12, 48, 58 as used in the power and communication system 10 is designed to carry both power voltage and signal voltage in a single wire in part due to the high conductivity of the carbon fiber core. An example of the power voltage carried by the wire design 12 is 120 V power used in standard household settings here in the United States. However it is contemplated that the wire 12 may easily be used to carry much greater voltages such as 230 V power or even greater power used in other countries. It is even further contemplated that the wire 12, 48, 58 is used to replace heavy gauge commercial or industrial wire applications to transmit even greater amounts of power. The wire 12, 48, 58 is suitable for transmitting both direct current and alternating current.

For direct current applications the low resistance of the carbon fiber core greatly reduces the current loss that occurs with traditional metal wires, thus the capabilities of direct current signals, such as cable signal transmissions is greatly increased. The signal voltage carried by the wire 12 is contemplated to be a standard signal voltage communication signal such as those signals found in standard coaxial cable wires in use today. However with the high conductivity of the carbon fiber core 14 it is contemplated that the signal voltage parameters may be changed in order to accommodate different frequencies, higher voltages, higher and amperes and overall greater speed and larger amounts of data that may be carried by the wire 12.

The power in communication system 10 further includes at least one input connector 24 at a first end of the wire 12, 48, 58 configured to be in contact with the carbon fiber core, the inner dielectric insulator (if present) and the electrically woven material 20 (if present). The power and communication system 10 further includes at least one output connector 26 at a second end of the wire 12, 40, 58 configured to be in contact with the carbon fiber core, the inner dielectric insulator (if present) and the electrically woven material (if present). While the present embodiment of the invention shows only a single input connector 24 and single output connector 26 connected to each end of the wire 12, 48, 58 it is within the scope of this invention for multiple connectors to be used depending on the particular application. For example some applications might require that the signal voltage or power voltage be split to go to different components, therefore connecting multiple connectors in order to split the power voltage and signal voltage might be useful for particular application.

The power and communication system 10 also includes a power source 28 and/or a signal source 29 connected to the input connector 24 for simultaneously transmitting the power voltage and signal voltage. In certain applications the wire 12, 40, 58 is only used to transmit a power voltage or signal voltage only. Therefore in such embodiments the input connector 24 is only connected to a power source 28 or a signal source 29. The power source 28 and the signal source 29 are any suitable power and signal source, such as a commercial or industrial power or signal input from a utility or cable company.

A device 30 is connected to the at least one output connector 26 and receives the power voltage and or a signal voltage from the at least one output connector 26. When both power voltage and signal voltage are passing through the wire design 12 the device 30 has a separator circuit 32 for separating and directing the power voltage and the signal voltage. The device 30 is connected to an appliance 34 that may be one selected from the group consisting of a television, computer, entertainment system, DVD player, thermostat, vehicle computer and a vehicle charging or infotainment system. The appliance 34 may be operable off of alternating current or direct-current, depending on the particular application. The wire design 12, 40, 58 is designed to be used for both alternating current and/or direct-current. The wire design 12, 48, 58 is also designed to be used without the device 30, so that the 2^{nd} connector 26 is connected directly to an appliance 34′. In another embodiment of the invention it is also within the scope of this invention for the device 30 to be integrated into an appliance 34″ along with the separator circuit 32, however in applications where the power communication system 10 is being retrofitted onto old appliances, the device 30 in separator circuit 32 may serve as an adapter in order to allow the appliance to the used in connection with the power and communication system 10, according to the teachings of the invention.

Referring now to FIGS. 2 and 3 the details of the wire design 12 in accordance with one embodiment of the present invention are shown. The wire design 12 has a carbon fiber core 14 including two or more individual carbon fibers 16 that are electrically conductive.

An inner dielectric insulator 18 surrounds the carbon fiber core 14 and an electrically conductive woven material 20 circumscribes the inner dielectric insulator 18 in the carbon fiber core 14. The electrically conductive woven material 20 can be formed of carbon fibers similar to the two or more carbon fibers 16 used in the carbon fiber core 14, woven into a mesh or lattice pattern. It is also within the scope of this invention that the conductive woven material 20 is a woven electrically conductive metallic or alloy material or wire made of copper, aluminum, steel, metal alloys or copper plated metal material. In a communication application the conductive woven material 20 functions as a shield to signal interference and loss. In the power communication system 10 the electrically conductive woven material 20 is used in combination with the carbon fiber core 14 in order to transmit the power voltage and signal voltage through the wire 12.

An outer insulator sheath 22 made of non-electrically conductive material circumscribes the electrically conductive woven material 20, the inner dielectric insulator 18 and the carbon fiber core 14. The outer insulator sheath 22 may be made of any type of material including cloth or fibers, polymers including vinyl, polyolefin, polyurethane, polyvinyl chloride (PVC) or other suitable generally nonconductive polymers.

The wire design 12 further includes the least one connector 24, 26 at each end of the wire design 12 configured to be in contact with the carbon fiber core 14, the inner dielectric insulator 18 and the electrically conductive woven material 20. The electrically conductive woven material 20 is a mesh material formed of copper or aluminum or some other type of metallic material that generally serves to prevent outside radiation from interfering with the voltage flowing through the carbon fiber core 14. The type of voltage flowing through the carbon fiber core 14 includes either a power voltage, a signal voltage or a combination of the two depending on the particular application. For example the wire design 12 in accordance with the present embodiment of the invention can be used to deliver a power voltage, a signal voltage and in some instances a combination of voltages, that are used for power and signal. Power voltage is generally a greater or higher voltage that is about 110 V AC or greater, while the signal voltage is generally a low voltage less than about 50 V DC. It is within the scope of this invention for the wire design 12 to be used with both direct-current and alternate current.

Between the outer insulator sheath 22 and the electrically conductive woven material 20 there is also an optional woven layer 23 that serves many purposes depending on the design of the wire 12. The optional woven layer in one aspect of the invention is a woven or braided cloth material used for heat insulation purposes. In another aspect of the invention the optional woven layer 23 is another electrically conductive woven material layer that is used to carry power or communications. An optional end cap 15 made of conductive metal such as copper or aluminum is placed over the end of the carbon fiber core 14. The end cap 15 can be used with any aspect of the invention and is shown in all of the figures.

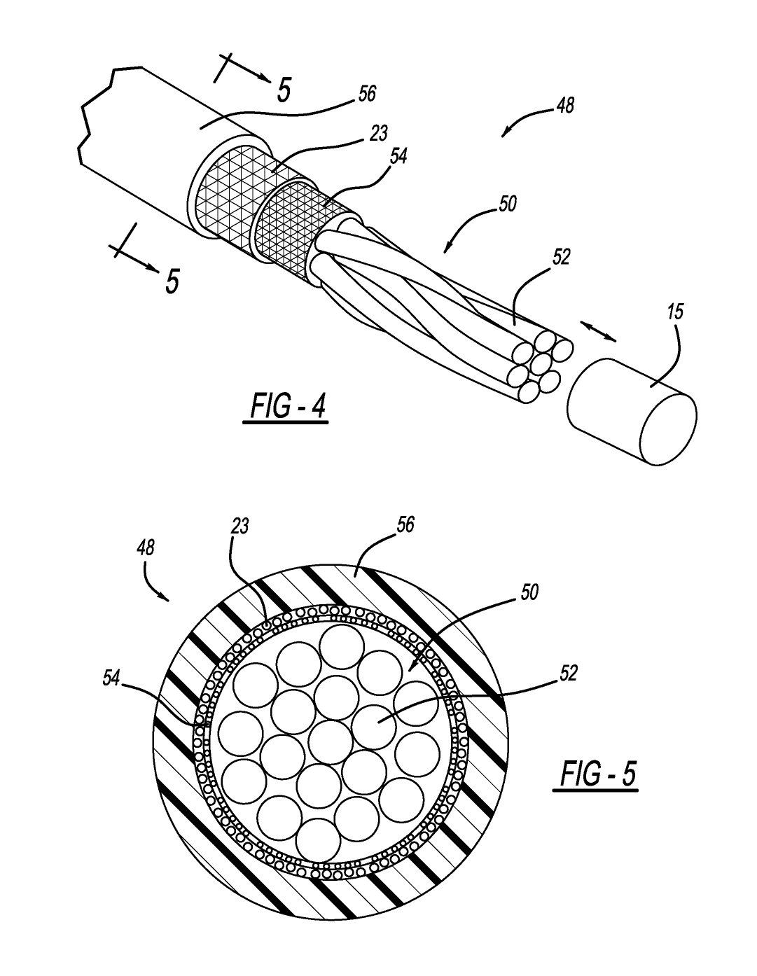

A second aspect of the invention shown in FIGS. 4 and 5 relates to a wire design 48 having a carbon fiber core 50 of two or more carbon fibers 52 that are electrically conductive. An electrically conductive woven material 54 circumscribes the carbon fiber core 50 and an outer insulator sheath 56 made of non-electrically conductive material circumscribes the electrically conductive woven material 54 and the carbon fiber core 50. Each end of the wire design 48 has at least one connector 24, 26 configured to be an electrical contact with the carbon fiber core 50 and the electrically conductive woven material 54.

The wire design 48 is generally configured to be used to supply a power voltage since the carbon fiber core 50 is not surrounded by both an inner di-electric insulator and electrically conductive woven material. Generally speaking in order to have a signal voltage transmitting through the second wire design 48 it is necessary to have an inner dielectric insulator and an electrically conductive shield surrounding the inner dielectric insulator in order to prevent external radiation from disrupting the signal voltage. Therefore the wire design 48 in accordance with the present embodiment of the invention is more suitable for higher voltages, used for providing operating power to the appliance 34.

There is also an optional woven layer 23 that serves many purposes depending on the design of the wire 48. The optional woven layer in one aspect of the invention is a woven or braided cloth material used for heat insulation purposes. In another aspect of the invention the optional woven layer 23 is another electrically conductive woven material layer that is used to carry power or communications. An optional end cap 15 made of conductive metal such as copper or aluminum is placed over the end of the carbon fiber core 14. The end cap 15 can be used with any aspect of the invention and is shown in all of the figures.

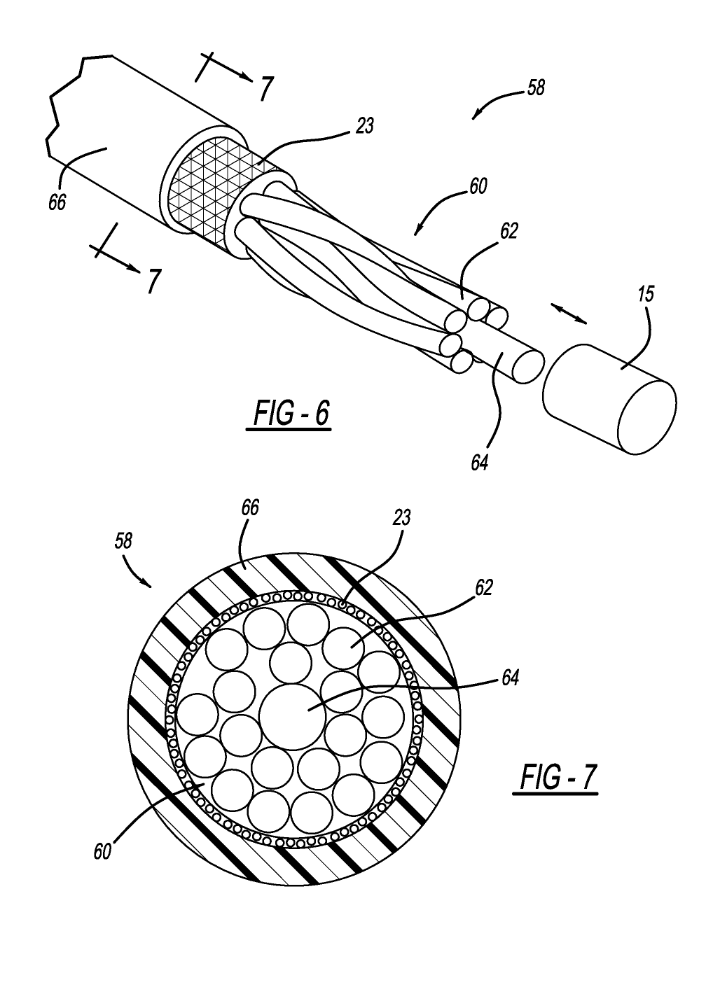

A third aspect of the invention shown in FIGS. 6 and 7 relates to a wire design 58 having a carbon fiber core 60 of two or more carbon fibers 62 that are electrically conductive. The two or more carbon fibers 62 are wrapped around a flexible backbone 64 in order to support the carbon fibers 62. An outer insulator sheath 66 made of non-electrically conductive material circumscribes the carbon fiber core 60 and flexible backbone 64. Each end of the wire design 58 has at least one connector 24, 26 configured to be in contact with the carbon fiber core 60 and the flexible backbone 64. The wire design 58 is generally configured to be used to supply a power voltage and provides distinct advantages over traditional wiring. For example traditional copper wiring is much more expensive and is required to have a much thicker gauge metal. In the present invention the flexible backbone 64 can be any type of thin gauge electrically conductive material, such as aluminum or copper wire. The carbon fibers 62 are wrapped around the flexible backbone 64. A voltage is applied to the flexible backbone 64 which is also transmitted, along the path of least resistance, through the carbon fiber 62. In the event that the carbon fibers 62 break, the flexible back bone 64 in the wire design 58 which will help to bridge the gap between the break in the carbon fibers 62 to the other carbon fibers 62 along the length of the wire. The high electrical conductivity of the carbon fibers 62 in combination with the use of the flexible backbone 64 allows the wire design 58 to continue to be highly conductive and suitable for high voltages and amps because any breaks in the carbon fibers 62 will be bridged by the flexible backbone 64.

There is also an optional woven layer 23 that serves many purposes depending on the design of the wire 12. The optional woven layer in one aspect of the invention is a woven or braided cloth material used for heat insulation purposes. In another aspect of the invention the optional woven layer 23 is another electrically conductive woven material layer that is used to carry power or communications. An optional end cap 15 made of conductive metal such as copper or aluminum is placed over the end of the carbon fiber core 14. The end cap 15 can be used with any aspect of the invention and is shown in all of the figures.

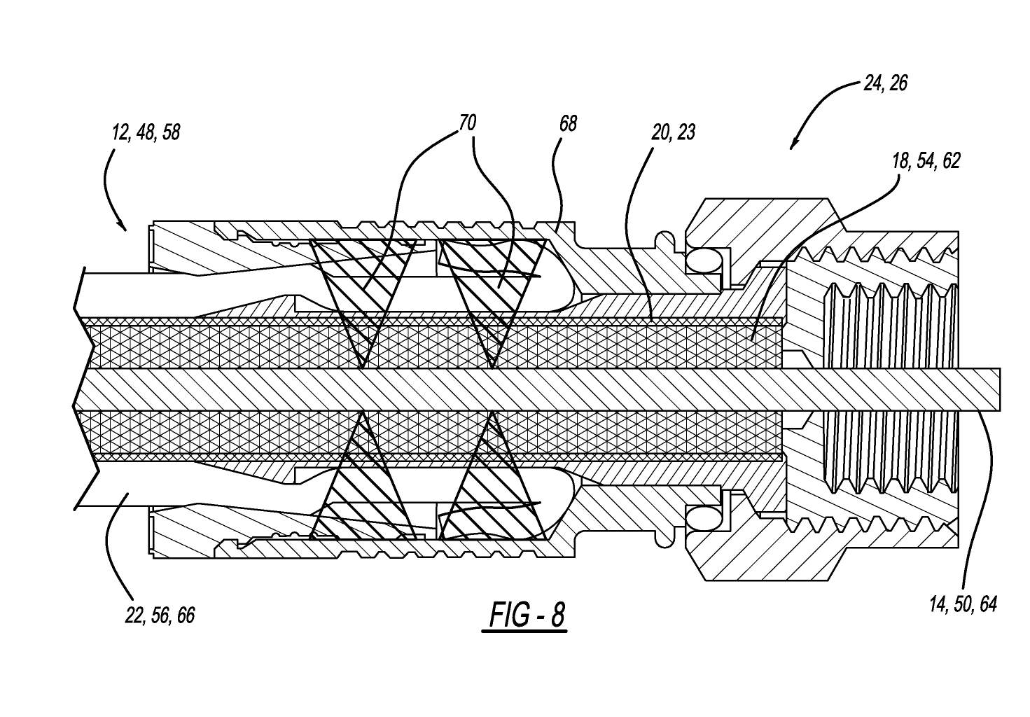

Referring now to FIG. 8 the details of the input connector and output connector 24, 26 are shown. The figure shows the end of the wire design 12, 48, 58 where the input connector 24 or output connector 26 are connected. The input connector 24 and output connector 26 have a connector body 68 that has optional teeth 70 that may penetrate or pierce the layers of the wire design 12, 48, 58. The teeth 70 are optional and are used in certain applications to provide an effective connection for transmitting a power voltage, while the use of teeth could interfere with or disrupt a signal voltage in a communications application. The connector design shown allows a user of the power and communication system 10 to quickly connect the input connector 24 and output connector 26 to an end of the wire design 12, 48, 58 and be able to supply a power voltage or signal voltage where it could be difficult to do so because of the flexibility of the carbon fibers of the carbon fiber core 14, 50, 60 provided by each of the wire designs 12, 48, 58.

The wire design 12, 48, 58 used in all aspects of the present invention can be used for many different applications including providing alternating current power, direct current power, low voltage signals and data signals. The wire design 12, 48, 58 can be used with many different types of connectors 24, 26 including coaxial connectors, prong and a pin power plugs, universal serial bus (USB) connectors including micro USB connectors, high definition multimedia interface (HDMI), mobile phone or smart phone charger cables, 32 pin connectors and 8 pin connectors including Lightning® connected designed by Apple, Inc. of Cupertino, Calif.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A wire design comprising:
a carbon fiber core of two or more carbon fibers that are electrically conductive;
an electrically conductive woven material circumscribing the carbon fiber core; and
an outer insulator sheath made of non-electrically conductive material circumscribing the electrically conductive woven material and the carbon fiber core.

2. The wire design of claim 1 further comprising:
at least one connector at each end of the wire design configured to be in contact with the carbon fiber core and the electrically conductive woven material.

3. The wire design of claim 3 wherein the at least one connector has one or more teeth that penetrate the outer insulation sheath and the one or more teeth contact the carbon fiber core and the electrically conductive woven material.

4. The wire design of claim 1 further comprising:
a flexible backbone of the carbon fiber core, wherein the two or more carbon fibers are wrapped around the flexible backbone in order to support the two or more carbon fibers.

5. The wire design of claim 4 wherein the flexible backbone is a thin gauge electrically conductive metal or alloy wire.

6. The wire design of claim 5 wherein the flexible backbone is electrically conductive material, one selected from the group consisting of copper, aluminum, steel and combinations thereof.

7. The wire design of claim 1 wherein the two or more carbon fibers are each carbon nanotube fibers.

8. The wire design of claim 1 wherein the woven electrically conductive mesh material is one selected from the group consisting of aluminum, copper and combinations thereof.

9. A wire design comprising:
a carbon fiber core of two or more carbon fibers that are electrically conductive;
a flexible backbone of the carbon fiber core, wherein the two or more carbon fibers are wrapped around the flexible backbone in order to support the two or more carbon fibers; and
an outer insulator sheath made of non-electrically conductive material circumscribing the flexible backbone and carbon fiber core.

10. The wire design of claim 9 further comprising:
at least one connector at each end of the wire design configured to be in contact with the carbon fiber core and the flexible backbone.

11. The wire design of claim 10 wherein the at least one connector has one or more teeth that penetrate the outer insulation sheath and the one or more teeth contact the carbon fiber core in the flexible backbone.

12. The wire design of claim 9 wherein the flexible backbone is a thin gauge electrically conductive metal or alloy wire.

13. The wire design of claim 9 wherein the flexible backbone is electrically conductive material, one selected from the group consisting of copper, aluminum, steel and combinations thereof.

14. The wire design of claim 9 wherein the two or more carbon fibers are each carbon nanotube fibers.

15. A power and communication system comprising:
a wire having a carbon fiber core of two or more carbon fibers that are electrically conductive;
a flexible backbone of the carbon fiber core, wherein the two or more carbon fibers are wrapped around the flexible backbone in order to support the two or more carbon fibers;
an outer insulator sheath made of non-electrically conductive material circumscribing the electrically conductive woven material, the inner dielectric insulator and the carbon fiber core;
at least one input connector at a first end of the wire configured to be in contact with the carbon fiber core;
at least one output connector at a second end of the wire configured to be in contact with the carbon fiber core;
a power source connected to the at least one input connector for transmitting a power voltage; and
a device connected to the at least one output connector for receiving the power voltage from the at least one output connector.

16. The power and communication system of claim 15 wherein the device is connected to an appliance.

17. The power and communication system of claim 16 wherein the appliance is one selected from the group consisting of a television, computer, entertainment system, DVD player, thermostat, a vehicle computer, a vehicle charging and infotainment system.

18. The power and communication system of claim 15 where in the device is integrated into an appliance.

19. The power and communication system of claim 18 where in the appliance is one selected from the group consisting of a television, computer, entertainment system, DVD player, thermostat, a vehicle computer, and a vehicle charging and infotainment system.

20. The power and communication system of claim 32 wherein the flexible backbone is a thin gauge electrically conductive metal or alloy wire.
